(19) United States
(12) Patent Application Publication
(10) Pub. No.: US 2024/0152615 A1
(43) Pub. Date: May 9, 2024

(54) DEVICE FOR EXTRACTING TRACE OF ACT, METHOD FOR EXTRACTING TRACE OF ACT, AND PROGRAM FOR EXTRACTING TRACE OF ACT

(71) Applicant: NIPPON TELEGRAPH AND TELEPHONE CORPORATION, Tokyo (JP)

(72) Inventors: Toshinori USUI, Musashino-shi, Tokyo (JP); Tomonori IKUSE, Musashino-shi, Tokyo (JP); Yuhei KAWAKOYA, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/280,478

(22) PCT Filed: Mar. 16, 2021
(86) PCT No.: PCT/JP2021/010700

§ 371 Date: Sep. 6, 2023

(51) Int. Cl. G06F 21/56; G06F 21/52

(52) U.S. Cl. CPC G06F 21/566; G06F 21/52; G06F 2221/033

(57) ABSTRACT

An activity trace extraction device executes malware to collect an analysis log including a plurality of activity traces of the malware, and executes the malware again to collect an environment change analysis log including the plurality of activity traces of the malware assumed in a case where an execution environment of a system and a device used at execution of the malware and information unique to application software are changed. The activity trace extraction device updates, based on the analysis log and the environment change analysis log, the analysis log by removing, from the analysis log, an activity trace different from an activity trace of the environment change analysis log among the plurality of activity traces included in the analysis log. The activity trace extraction device generates trace information of the malware independent of the execution environment based on the analysis log updated.

### TECHNICAL FIELD

The present invention relates to an activity trace extraction device, an activity trace extraction method, and an activity trace extraction program that are useful for detecting malware.

### BACKGROUND ART

As malware becomes more sophisticated, malware that is difficult to detect with conventional anti-virus software which makes detection based on a signature has been increasing. Further, detection with a dynamic analysis sandbox that runs sent/received files in an isolated environment for analysis to detect malware based on malicious behavior observed is perceived to be an environment for analysis and avoided by a method of checking a degree of deviation from a general user environment or any other method.

In light of such a situation, an anti-malware technology called endpoint detection and response (EDR) has been used. The EDR is not an environment prepared for analysis but an agent installed on a user terminal, and is operable to continuously monitor the behavior of the user terminal. Then, malware is detected by using an indicator of compromise (IOC) that is prepared in advance and is a behavior signature for detecting a trace left when the malware is active. To be specific, the EDR checks the behavior observed in the terminal against the IOC, and in a case where a match is found therebetween, the EDR detects that the terminal might be infected with the malware.

Thus, whether or not malware can be detected by the EDR depends on whether or not an IOC useful for detecting certain malware is held. On the other hand, if the IOC matches a trace of the activity not only of the malware but also of legitimate software, then this poses a problem of a false-positive result. It is therefore necessary to selectively extract a trace useful for detection and use the same as an IOC, rather than merely randomly using the trace of the malware as an IOC to increase the number of IOCs.

Further, also from the viewpoint of the IOC that the EDR can check at a time, it is necessary to selectively extract a trace useful for detection and set the same as an IOC. Specifically, in general, the more IOCs the EDR has, the longer it takes for the EDR to check; thus it is desirable to have a combination of IOCs to detect more types of malware with a smaller number of IOCs. At this time, if an IOC is created based on an activity trace not useful for detection, then a time for check might be unnecessarily increased.

At present, new malware is created every day and IOCs corresponding thereto also continue to change. Therefore, in order to continuously cope with such a situation, it is necessary to automatically analyze malware to extract an activity trace, and create IOCs accordingly. The IOCs are created based on the activity trace acquired by analyzing the malware. In general, traces acquired by execution while the behavior of malware is monitored are collected, and the traces are normalized, selected as a combination appropriate for detection, and so on, so that IOCs are created.

In light of the above, technologies have been urged for selectively and automatically extracting activity traces useful for detection of malware. For example, the technologies for extracting activity traces include technologies described in Non Patent Literature 1 and Non Patent Literature 2.

Non Patent Literature 1 proposes a method for extracting a trace pattern observed repeatedly in a plurality of pieces of malware to use the trace pattern as an IOC.

Further, Non Patent Literature 2 proposes a method for extracting a set of traces occurring among a plurality of pieces of malware in one family to prevent an increase in complexity of an IOC by a set optimization method, and thereby to automatically create an IOC that is easy for humans to understand.

According to the methods of Non Patent Literatures 1 and 2 or any other method, it is possible to automatically extract an IOC that can contribute to detection of malware from an execution trace log. The execution trace herein is to track an execution status of a program by sequentially recording the behavior from various viewpoints at the time of execution. Further, in order to achieve this, there is a program having a function to monitor and record the behavior, and the program is referred to as a tracer. For example, what records executed application programming interfaces (APIs) in sequence is referred to as an API trace, and a program for implementing the API trace is referred to as an API tracer.

### CITATION LIST

### Non Patent Literature

Non Patent Literature 1: Christian Doll et al. “Automated Pattern Inference Based on Repeatedly Observed Malware Artifacts.” Proceedings of the 14th International Conference on Availability, Reliability and Security. 2019.
Non Patent Literature 2: Yuma Kurogome et al. “EIGER: Automated IOC Generation for Accurate and Interpretable Endpoint Malware Detection.” Proceedings of the 35th Annual Computer Security Applications Conference. 2019.

### SUMMARY OF INVENTION

### Technical Problem

However, in the foregoing conventional technologies (Non Patent Literatures 1 and 2), there is a problem that time dependency and environmental dependency of activity traces are not considered and thus an activity trace that is not effective for detection may be also set as an IOC.

As used herein, the time dependency of an activity trace is a characteristic that the activity trace changes depending on temporal information at the execution of malware. The temporal information includes time, elapsed time from startup, and so on. A time-dependent activity trace cannot be used as an IOC because the temporal information in an analysis environment collected is generally different from the temporal information in an environment that has actually suffered an attack.

In the meantime, the environmental dependency of an activity trace is a characteristic that the activity trace changes depending on environmental information at the execution of malware. The environmental information includes various settings information of a system or a device. For example, a case may occur in which the activity trace is changed based on a UUID of a system disk. A time-dependent activity trace also cannot be used as an IOC due to a difference in environmental information between the analysis environment collected and the environment that has actually suffered an attack.

In essence, determination on whether or not the collected activity trace has the time dependency or the environmental dependency is important in order to selectively extract an activity trace effective for detection to create an IOC.

The present invention has been made in view of the above, and an object thereof is to provide an activity trace extraction device, an activity trace extraction method, and an activity trace extraction program that can selectively extract an activity trace effective for detection and create an effective IOC.

### Solution to Problem

In order to solve the problem described above and achieve the object, an activity trace extraction device according to the present invention includes: a collection unit that executes malware to collect an analysis log including a plurality of activity traces of the malware, and executes the malware again to collect an environment change analysis log including the plurality of activity traces of the malware assumed in a case where an execution environment of a system and a device used at execution of the malware and information unique to application software are changed; an update unit that updates, based on the analysis log and the environment change analysis log, the analysis log by removing, from the analysis log, an activity trace different from an activity trace of the environment change analysis log among the plurality of activity traces included in the analysis log; and a generation unit that generates trace information of the malware independent of the execution environment based on the analysis log updated.

### Advantageous Effects of Invention

The time dependency and the environmental dependency of the activity trace are detected, so that an activity trace effective for detection can be selectively extracted to create an effective IOC.

### BRIEF DESCRIPTION OF DRAWINGS

FIG. 1 is an explanatory diagram of processing of an activity trace extraction device according to the present example.

FIG. 2 is a functional block diagram illustrating a configuration of an activity trace extraction device according to the present example.

FIG. 3 is a diagram illustrating an example of a data structure of a history DB.

FIG. 4 is a diagram illustrating an example of an analysis log and an activity trace.

FIG. 5 is a diagram illustrating an example of a time-dependent activity trace.

FIG. 6 is a diagram illustrating an example of an environment-dependent activity trace.

FIG. 7 is a diagram illustrating an example of comparison between analysis logs.

FIG. 8 is a flowchart depicting a processing procedure of an activity trace extraction device according to the present example.

FIG. 9 is a flowchart depicting a processing procedure for identifying a dependent activity trace by comparison between analysis logs.

FIG. 10 is a flowchart depicting a processing procedure for changing environment information on a system by using an API hook.

FIG. 11 is a flowchart depicting a processing procedure for changing environment information on a system by changing an analysis environment.

FIG. 12 is a diagram illustrating an example of a computer that executes an activity trace extraction program.

### DESCRIPTION OF EMBODIMENTS

Hereinafter, an example of an activity trace extraction device, an activity trace extraction method, and an activity trace extraction program disclosed in the present application will be described in detail with reference to the drawings. Note that the present invention is not limited to the example.

### EXAMPLES

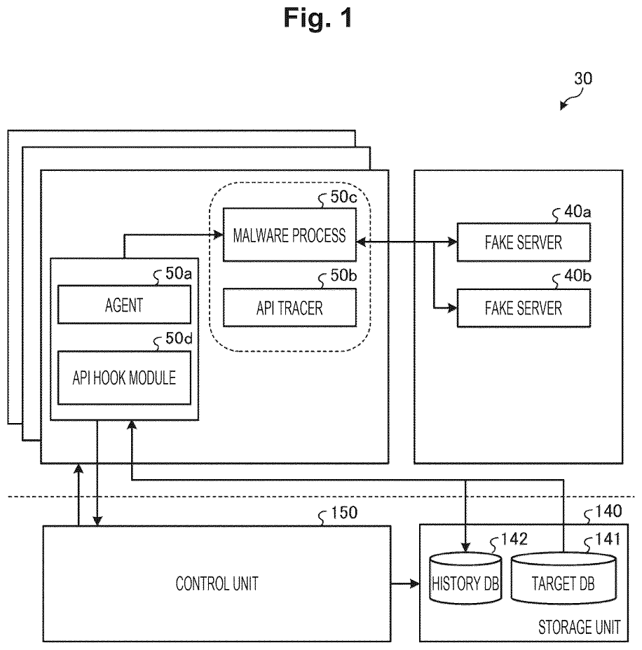

FIG. 1 is an explanatory diagram of processing of an activity trace extraction device according to the present example. As illustrated in FIG. 1, the activity trace extraction device includes a storage unit 140 and a control unit 150.

The storage unit 140 is implemented by a semiconductor memory element such as a random access memory (RAM) or a flash memory, or a storage device such as a hard disk or an optical disk. The storage unit 140 includes a target database (DB) 141 and a history DB 142.

The target DB 141 retains data, used to extract an activity trace, on a plurality of pieces of malware. The history DB 142 retains information on an analysis log at an execution of malware.

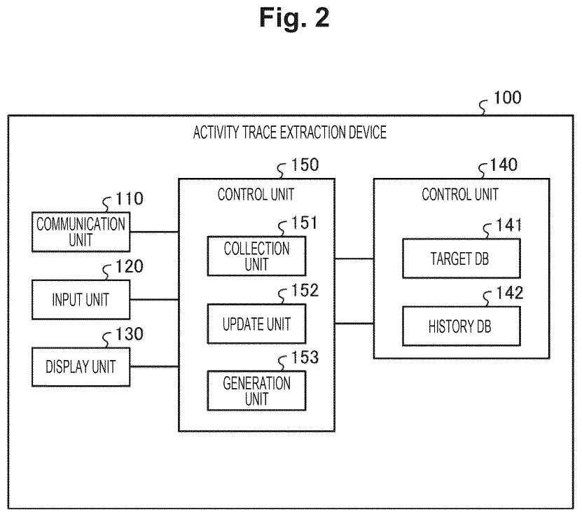

The control unit 150 is implemented using a central processing unit (CPU) or the like. The control unit 150 executes an agent 50a, an API tracer 50b, and an API hook module 50d in a virtual environment 30. The agent 50a reads malware from the target DB 141, so that a malware process 50c is executed. The control unit 150 executes a fake server 40a and a fake server 40b in the virtual environment 30. In FIG. 1, for convenience of explanation, the virtual environment 30 is illustrated outside the control unit 150, but the virtual environment 30 is executed inside the control unit 150. Further, as described with reference to FIG. 2, the control unit 150 includes a collection unit 151, an update unit 152, and a generation unit 153. For example, the processing executed in the virtual environment 30 is executed by the collection unit 151.

For example, the fake server 40a is a fake server that responds as a domain name system (DNS) server when access is accepted from the malware process 50c. The fake server 40b is a fake server that responds as a hypertext transfer protocol (HTTP) server when access is accepted from the malware process 50c. The fake servers 40a and 40b may be fake servers that execute processing of other servers. Alternatively, an actual environment appropriately prepared may be used without the fake servers.

The control unit 150 executes processing for extracting an activity trace, processing for extracting time dependency, processing for extracting environmental dependency, and processing for creating an IOC.

The “processing for extracting an activity trace” will be described. The control unit 150 uses the API tracer 50b to execute the malware process 50c, collects an activity trace from an analysis log traced by the API tracer 50b, and registers information on the activity trace into the history DB 142.

In a case where the target for which an IOC is to be created is executable malware, the control unit 150 traces a system API; and in a case where the target for which an IOC is to be created is script malware, the control unit 150 traces a script API. The malware process 50c accesses the fake servers 40a, 40b, and so on to execute various types of processing (other network communication, file operation, registry operation, process generation, and the like).

The API tracer 50b monitors the operation of the malware process 50c to acquire an analysis log. The API tracer 50b outputs the analysis log acquired to the agent 50a. For example, the generation unit 153 described later defines in advance, on the basis of the information acquired by the API tracer 50b, from which activity trace (network communication, file operation, registry operation, process generation, and so on, for example) an IOC is to be created and an API having a function corresponding to the activity trace, and searches the analysis log for the APIs and arguments to collect the activity trace of the malware process 50c.

In general, in order for the malware process 50c to achieve malicious behavior, it is necessary to invoke an API to interact with a system (operating system, each device connected to the activity trace extraction device, or another external device connected via a network, for example). Since even behavior of leaving an activity trace is no exception, the generation unit 153 uses the API tracer 50b to monitor the API, so that the activity trace of the target malware process 50c can be collected without missing anything.

The environment necessary to extract the activity trace is implemented by an API hook to detect time dependency and environmental dependency described later. For example, the API hook module 50d has a function to set an API hook to apply a change to an execution result of the API.

The “processing for extracting time dependency” will be described. The control unit 150 compares the analysis logs traced by the API tracer 50b in two environments of a first environment and a second environment with different times, and thereby to identify a time-dependent activity trace among a plurality of activity traces included in the analysis logs.

The first environment and the second environment are different in time information of the environment in which the malware process 50c executes processing. For example, the control unit 150 executes the malware process 50c at a first time, acquires a plurality of activity traces collected by the API tracer 50b as a first analysis log in the first environment, and registers the first analysis log into the history DB 142.

The control unit 150 executes the malware process 50c at a second time after a predetermined time from the first time, acquires a plurality of activity traces collected by the API tracer 50b as a second analysis log in the second environment, and registers the second analysis log into the history DB 142.

The control unit 150 compares the first analysis log and the second analysis log collected in the two execution environments, and in a case where there is a difference in activity trace, the control unit 150 detects that the activity trace corresponding to the difference has time dependency.

Immediately before executing the malware process 50c to acquire the activity traces in the first environment, the control unit 150 creates a snapshot (retaining information at the first time) of the first environment, and when a certain period of time has elapsed since the snapshot, the control unit 150 executes the malware process 50c again, so that the second analysis log in the second environment can be collected.

The control unit 150 may implement the difference between the time information of the first environment and the time information of the second environment by using the API hook to hook an API for retrieving a time and an elapsed time after startup and applying a change so as to return a value different from the actual value.

The “processing for extracting environmental dependency” will be described. The control unit 150 compares the analysis logs traced by the API tracer 50b in two environments of the first environment and a third environment that are different in a system, a device, and so on allocated to the malware process 50c, and thereby identifies an environment-dependent activity trace among a plurality of activity traces included in the analysis logs.

The first environment and the third environment are different in information on a system and a device of the environment in which the malware process 50c executes processing.

The control unit 150 identifies whether or not the first analysis log includes an API call for an API for retrieving information on a system or a device described in a list of APIs (APIs for retrieving information on a system or a device). In a case where the first analysis log includes no API call for the API for retrieving information on a system or a device, the control unit 150 determines that there is no environment-dependent activity trace in the first analysis log.

On the other hand, in a case where the first analysis log includes an API call for the API for retrieving information on a system or a device, the control unit 150 determines that there may be environmental dependency in any of the activity traces included in the first analysis log.

In this case, in the first environment, the control unit 150 allocates, to the virtual environment 30, a system or a device that substitutes for (differs from) information retrieved by the API (API for retrieving information on a system or a device) called by the malware process 50c, and then executes the malware process 50c in the third environment. The control unit 150 registers, in the third environment, a third analysis log traced by the API tracer 50b into the history DB 142.

The control unit 150 may implement the difference in information on a system or a device between the first environment and the third environment by using the API hook to hook the API for retrieving information on a system or a device and applying a change so as to return a value different from the actual value. Further, the control unit 150 may hook an API for retrieving information unique to specific application software (hereinafter, referred to as an application) (settings information on a specific application, for example) and apply a change so as to return a value different from the actual value, and thereby may implement a difference in information unique to an application between the first environment and the third environment.

The control unit 150 compares the first analysis log and the third analysis log collected in the two execution environments, and in a case where there is a difference in activity trace, the control unit 150 detects that the activity trace corresponding to the difference has environmental dependency.

For example, in a case where the malware process 50c calls an API for retrieving information on a UUID of a disk (system information), the control unit 150 changes the information on the UUID of the disk held by the operating system via the agent 50a. In a case where the malware process calls an API for retrieving information on the number of cores of the CPU (device information), the control unit 150 changes the number of cores allocated to a virtual machine. The control unit 150 may make the implementation by using the API hook to hook the API for retrieving information on a system or a device and applying a change so as to return a value different from the actual value.

The “processing for creating an IOC” will be described. The control unit 150 updates the first analysis log by removing the time-dependent activity trace and the environment-dependent activity trace from the activity traces of the first analysis log stored in the history DB 142. The control unit 150 creates an IOC based on the updated first analysis log. The control unit 150 may create an IOC using the technologies described in Non Patent Literatures 1 and 2.

Next, an example of the configuration of the activity trace extraction device that executes the processing described with reference to FIG. 1 will be described. FIG. 2 is a functional block diagram illustrating the configuration of the activity trace extraction device according to the present example. As illustrated in FIG. 2, the activity trace extraction device 100 includes a communication unit 110, an input unit 120, a display unit 130, the storage unit 140, and the control unit 150.

The communication unit 110 is a communication interface that transmits and receives various types of information to and from an external device connected via a network or the like. The communication unit 110 is implemented by a network interface card (NIC) or the like, and performs communication between an external device and the control unit 150 via a telecommunication line such as a local area network (LAN) or the Internet.

The input unit 120 is an input interface that receives various operations from an operator of the activity trace extraction device 100. For example, the input unit 120 includes an input device such as a keyboard or a mouse.

The display unit 130 is an output device that outputs information acquired from the control unit 150, and is implemented by a display device such as a liquid crystal display, a printing device such as a printer, or any other device.

The storage unit 140 includes the target DB 141 and the history DB 142. The storage unit 140 corresponds to the storage unit 140 described with reference to FIG. 1. The target DB 141 retains data, used to extract an activity trace, on a plurality of pieces of malware. The malware may be executable malware or script malware.

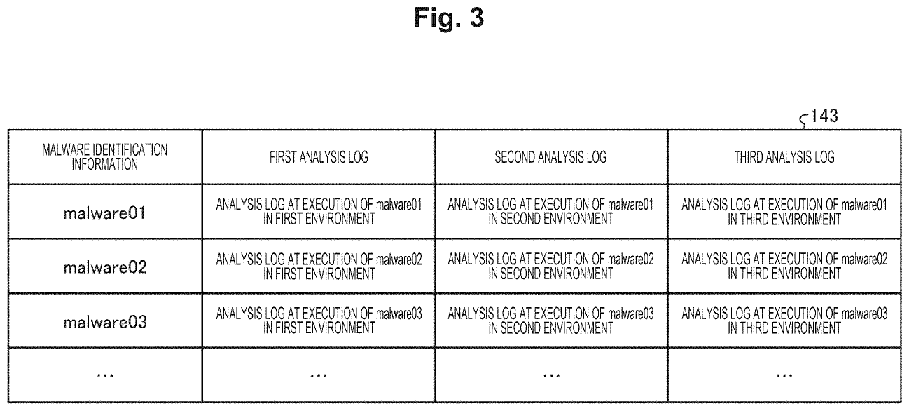

The history DB 142 retains information on analysis logs executed in each environment. FIG. 3 is a diagram illustrating an example of a data structure of the history DB. As illustrated in FIG. 3, the history DB 143 retains malware identification information, a first analysis log, a second analysis log, and a third analysis log.

The malware identification information is information for identifying malware. The first analysis log is an analysis log collected by executing corresponding malware in the first environment. The second analysis log is an analysis log collected by executing corresponding malware in the second environment. The third analysis log is an analysis log collected by executing corresponding malware in the third environment.

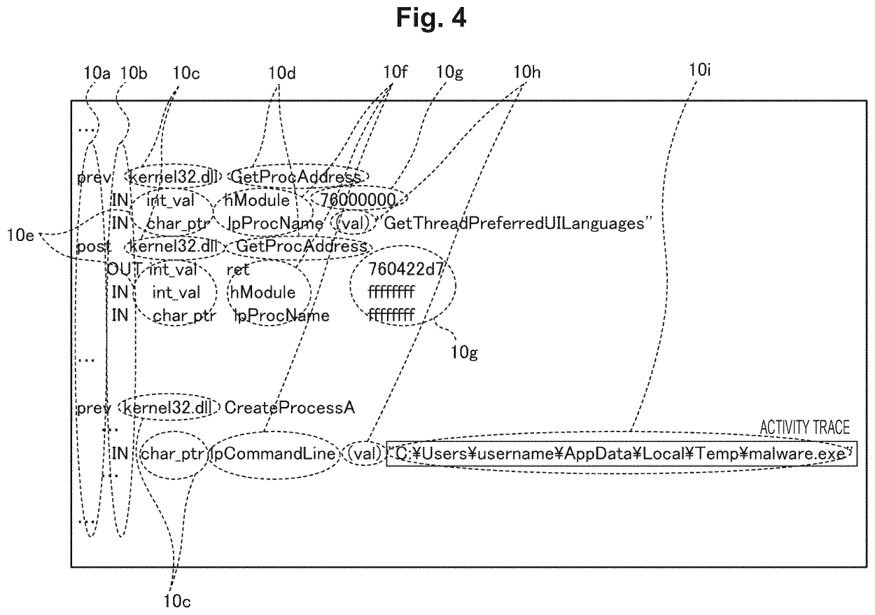

FIG. 4 is a diagram illustrating an example of an analysis log and an activity trace. In FIG. 4, “prev” contained in a region 10a indicates pre-execution of an API, and “post” contained in the region 10a indicates post-execution of an API. “IN” contained in a region 10b indicates an input, and “OUT” contained therein indicates an output. A character string contained in a region 10c indicates a DLL name. A character string contained in a region 10d indicates an API name. A character string contained in a region 10e indicates a type. A character string contained in a region 10f corresponds to a variable name. A character string and a numerical value contained in a region 10g correspond to an argument. “val” contained in a region 10h indicates that a value obtained by dereferencing a pointer is recorded. A region 10i contains an activity trace. The example of FIG. 4 shows that an lpCommandLine argument for a CreateProcess is an activity trace related to a process in this malware.

The control unit 150 executes processing for extracting an activity trace, processing for extracting time dependency, processing for extracting environmental dependency, and processing for creating an IOC. The control unit 150 corresponds to the control unit 150 described with reference to FIG. 1. For example, the control unit 150 includes the collection unit 151, the update unit 152, and the generation unit 153.

The collection unit 151 reads malware from the target DB 141 and executes the malware in each environment to collect an analysis log in each environment.

For example, the collection unit 151 executes the agent 50a, the API tracer 50b, and the fake servers 40a and 40b in the virtual environment 30 described with reference to FIG. 1. The collection unit 151 reads malware from the target DB 141 and executes the malware to run the malware process 50c. The collection unit 151 executes the malware process 50c to collect an analysis log traced by the API tracer 50b.

The collection unit 151 executes the malware process 50c in the first environment to collect the first analysis log. In a case where collecting the first analysis log, the collection unit 151 uses the API hook or the like to acquire information (snapshot) on the first time at which the malware process 50c has been executed.

The collection unit 151 executes the malware process 50c again in the second environment after a certain period of time has elapsed since the first time, and collects the second analysis log.

In a case where the first analysis log is scanned and the first analysis log includes an API call for the API for retrieving information on a system or a device, the collection unit 151 determines that any of the activity traces included in the first analysis log has environmental dependency.

The collection unit 151 executes the malware process 50c in the third environment by changing to system information different from the system information in the first environment. The collection unit 151 collects, in the third environment, the third analysis log traced by the API tracer 50b.

In a case where the first analysis log includes no API call for the API for retrieving information on a system or a device, the collection unit 151 determines that there is no environment-dependent activity trace in the first analysis log.

The collection unit 151 correlates the collected first analysis log, second analysis log, and third analysis log with the malware identification information to register the resultant into the history DB 142.

The collection unit 151 executes the foregoing processing also to another piece of malware registered in the target DB 141 to repeatedly execute the processing of collecting the first analysis log, the second analysis log, and the third analysis log to register the collected analysis logs into the history DB 142.

The update unit 152 is a processing unit that updates the first analysis log by removing the time-dependent activity trace and the environment-dependent activity trace from the first analysis log. For example, the update unit 152 removes, as the time-dependent activity trace, an activity trace that does not match the activity trace of the second analysis log among the activity traces of the first analysis log.

The update unit 152 removes, as the environment-dependent activity trace, an activity trace that does not match the activity trace of the third analysis log among the activity traces of the first analysis log.

The update unit 152 repeatedly executes the processing described above for each first analysis log registered in the history DB 142.

The generation unit 153 creates an IOC based on the first analysis log updated by the update unit 152. The generation unit 153 may create an IOC using the technologies described in Non Patent Literatures 1 and 2. The generation unit 153 may store the created IOC in the storage unit 140 or may notify the same to an external device.

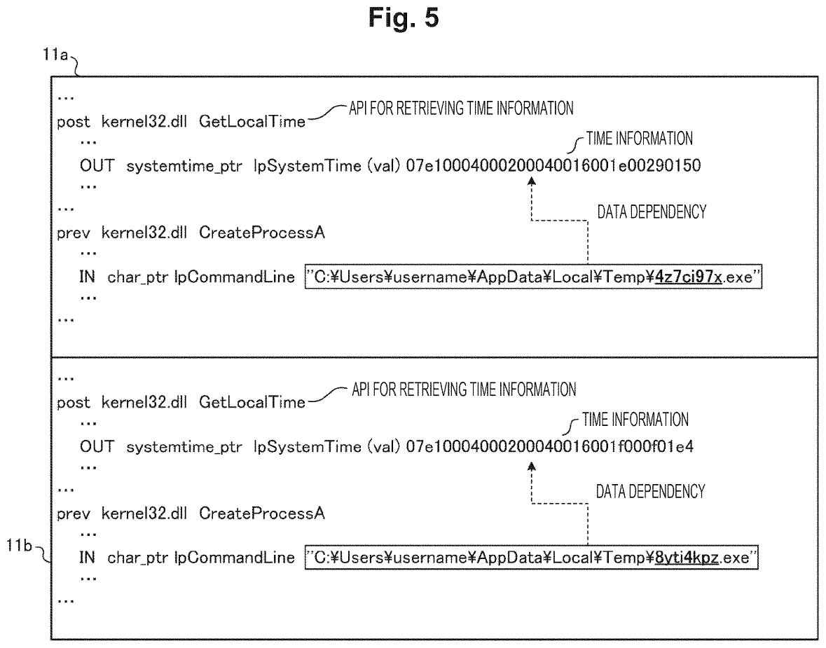

FIG. 5 is a diagram illustrating an example of the time-dependent activity trace. In FIG. 5, “GetLocalTime” is a system API for retrieving time information, and retrieves time information of a system time. It is assumed that there is data dependency between “lpSystemTime” storing the system time, which is an output value of “GetLocalTime”, and an activity trace of a process name. That is, it is assumed that the process name is determined on the basis of the value of “lpSystemTime”.

It is assumed that, for example, an analysis log 11a corresponds to the first analysis log, and an analysis log 11b corresponds to the second analysis log. In a case where there is a difference between the system time of the analysis log 11a and the system time of the analysis log 11b, the activity trace is also different accordingly. This is the time dependency.

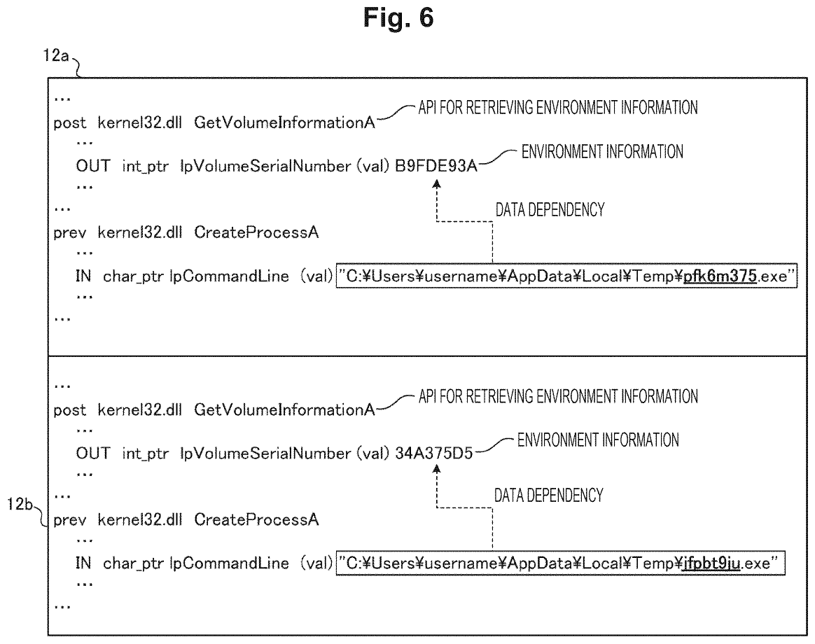

FIG. 6 is a diagram illustrating an example of the environment-dependent activity trace. In FIG. 6, “GetVolumeInformationA” is a system API for retrieving environment information regarding a volume. It is assumed that there is data dependency between “lpVolumeSerialNumber” storing a serial number of the volume, which is an output value of “GetVolumeInformationA”, and an activity trace of a process name. That is, it is assumed that the process name is determined on the basis of the serial number of the volume.

It is assumed that, for example, an analysis log 12a corresponds to the first analysis log, and an analysis log 12b corresponds to the third analysis log. In a case where there is a difference between the serial number of the analysis log 12a and the serial number of the analysis log 11b, the activity trace is also different accordingly. This is the environmental dependency.

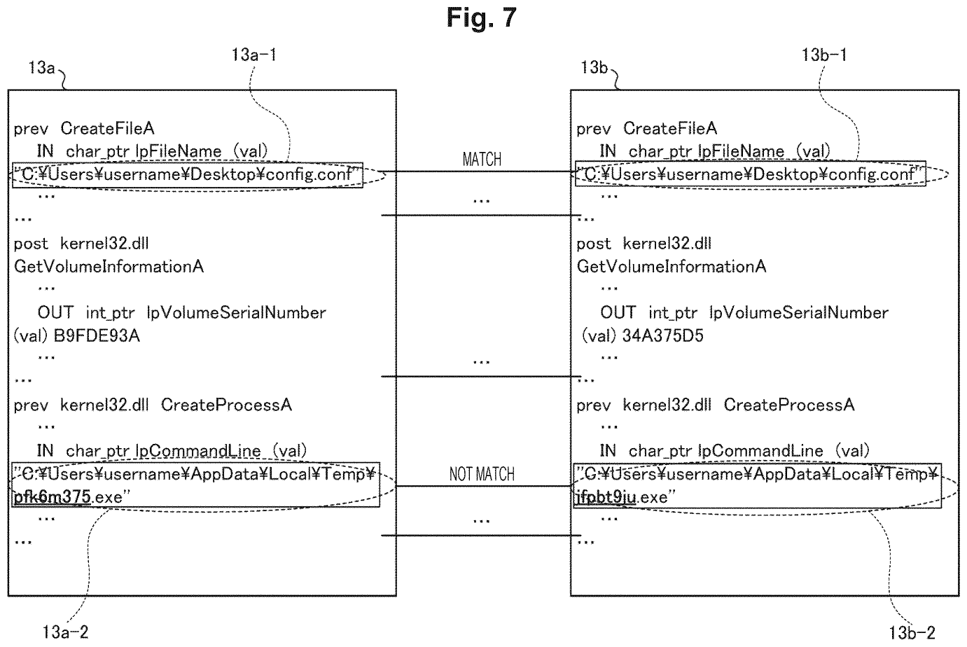

FIG. 7 is a diagram illustrating an example of comparison between analysis logs. FIG. 7 illustrates an analysis log 13a and an analysis log 13b. The update unit 152 correlates API calls of the two analysis logs 13a and 13b with each other. The correlation is performed by, for example, extracting a longest common part and so on, but the correlation is not limited thereto. The update unit 152 compares activity traces of the corresponding API calls with each other to identify whether or not the activity traces match. In the example illustrated in FIG. 7, a character string in a region 13a-1 matches a character string in a region 13b-1, but a character string in a region 13a-2 does not match a character string in a region 13b-2. For example, the update unit 152 removes the mismatched character string in the region 13a-2 and the mismatched character string in the region 13b-2.

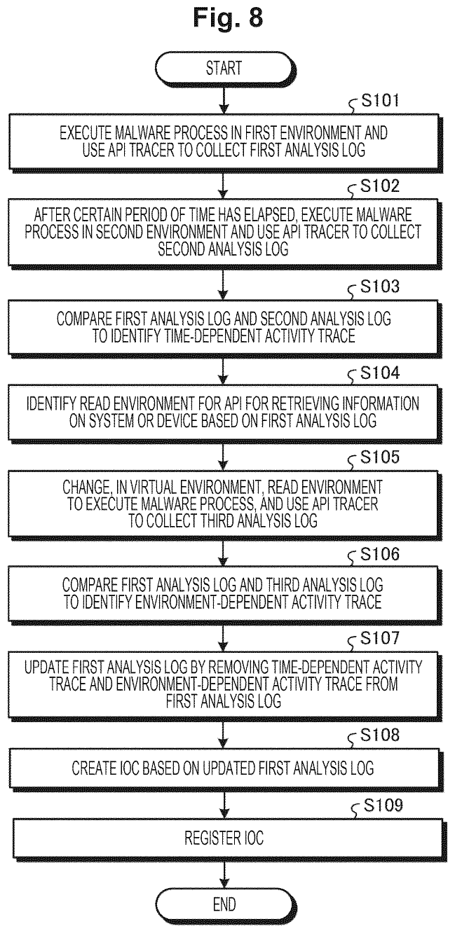

Next, an example of a processing procedure of the activity trace extraction device 100 according to the present example will be described. FIG. 8 is a flowchart depicting the processing procedure of the activity trace extraction device according to the present example. The collection unit 151 of the activity trace extraction device 100 executes the malware process 50c in the first environment and uses the API tracer 50b to collect the first analysis log (step S101).

After a certain period of time has elapsed, the collection unit 151 executes the malware process 50c in the second environment and uses the API tracer 50b to collect the second analysis log (step S102). The update unit 152 of the activity trace extraction device 100 compares the first analysis log and the second analysis log to identify a time-dependent activity trace (step S103).

The collection unit 151 identifies a read environment for an API for retrieving information on a system or a device based on the first analysis log (step S104). The collection unit 151 changes, in a virtual environment, the read environment to execute the malware process 50c, and uses the API tracer 50b to collect the third analysis log (step S105).

The update unit 152 compares the first analysis log and the third analysis log to identify an environment-dependent activity trace (step S106). The update unit 152 updates the first analysis log by removing the time-dependent activity trace and the environment-dependent activity trace from the first analysis log (step S107).

The generation unit 153 creates an IOC based on the updated first analysis log (step S108). The generation unit 153 registers the IOC into the storage unit 140 (step S109).

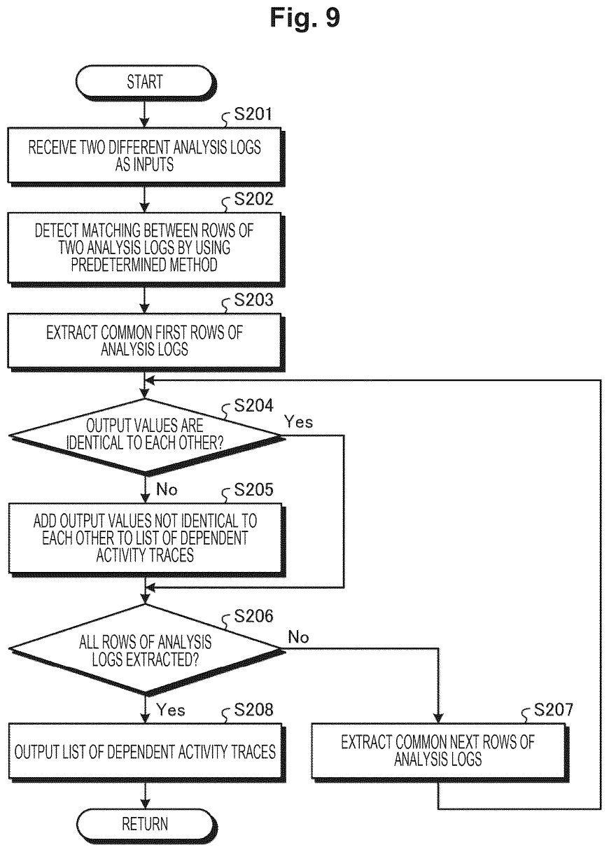

FIG. 9 is a flowchart depicting a processing procedure for identifying a dependent activity trace by comparison between analysis logs. The processing in FIG. 9 corresponds to steps S103 and S106 in FIG. 8.

As illustrated in FIG. 9, the control unit 150 of an information processing device 100 receives two different analysis logs as inputs (step S201). The control unit 150 detects matching between rows of the two analysis logs by using a predetermined method (step S202). For example, the control unit 150 executes the processing of step S202 by extracting a longest common part and so on.

The control unit 150 extracts common first rows of the analysis logs (step S203). In a case where the output values are identical to each other (Yes in step S204), the processing of the control unit 150 proceeds to step S206. On the other hand, in a case where the output values are not identical to each other (No in step S204), the control unit 150 adds the output values that are not identical to each other to a list of dependent activity traces (step S205).

In a case where all the rows of the analysis logs have not yet been extracted (No in step S206), the control unit 150 extracts common next rows of the analysis logs (step S207) and the processing of the control unit 150 proceeds to step S204. On the other hand, in a case where all the rows of the analysis logs have been extracted (Yes in step S206), the control unit 150 outputs the list of the dependent activity traces (step S208).

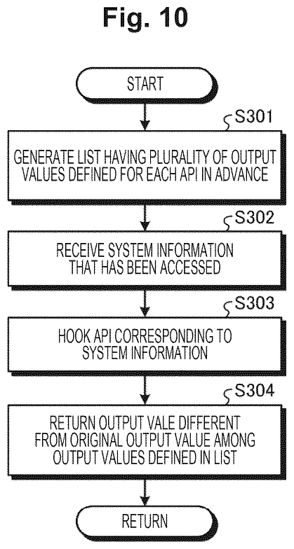

FIG. 10 is a flowchart depicting a processing procedure for changing environment information on a system by using the API hook. As illustrated in FIG. 10, the control unit 150 of the information processing device 100 generates a list in which a plurality of output values is defined for each API in advance (step S301). The collection unit 151 receives system information that has been accessed (step S302).

The control unit 150 hooks an API corresponding to the system information (step S303). The control unit 150 returns an output value different from the original output value among the output values defined in the list (step S304).

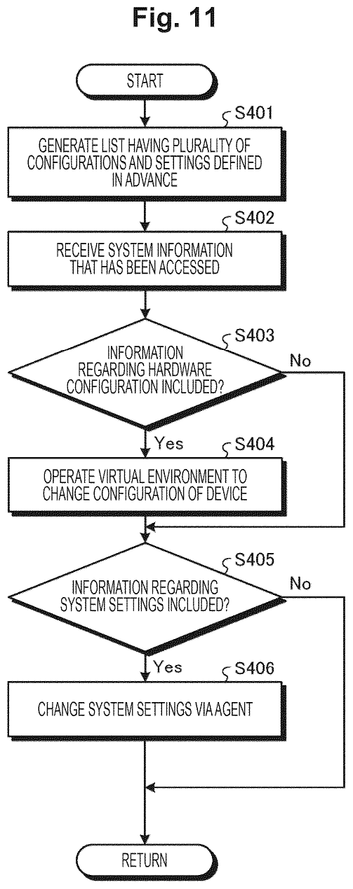

FIG. 11 is a flowchart depicting a processing procedure for changing environment information on a system by changing an analysis environment. As illustrated in FIG. 11, the control unit 150 generates a list in which a plurality of configurations and settings is defined in advance (step S401). The control unit 150 receives system information that has been accessed (step S402). In a case where the system information does not include information regarding the hardware configuration (No in step S403), the processing of the control unit 150 proceeds to step S405.

In a case where the system information includes the information regarding the hardware configuration (Yes in step S403), the control unit 150 operates the virtual environment 30 to change the configuration of the device (step S404).

In a case where the system information does not include information regarding the system settings (No in step S405), the control unit 150 finishes the processing.

On the other hand, in a case where the system information includes the information regarding the system settings (Yes in step S405), the control unit 150 changes the settings of the system via the agent 50a (step S406).

Next, effects of the activity trace extraction device 100 according to the present example will be described. The activity trace extraction device 100 can selectively extract an activity trace effective for detection to create an effective IOC by detecting the time dependency and the environmental dependency of the activity trace.

For example, the activity trace extraction device 100 executes malware in the first environment to collect the first analysis log. The activity trace extraction device 100 executes the malware in the second environment after a predetermined period of time from the first environment to collect the second analysis log. The activity trace extraction device 100 identifies a time-dependent activity trace based on the first analysis log and the second analysis log.

In addition, the activity trace extraction device 100 collects, in the first environment, the third analysis log by executing malware in the third environment in which the environment of the system or the device that have been used by the malware is changed. The activity trace extraction device 100 identifies an environment-dependent activity trace based on the first analysis log and the third analysis log.

The activity trace extraction device 100 removes the time-dependent activity trace and the environment-dependent activity trace from the first analysis log to update the first analysis log, and creates an IOC based on the updated first analysis log. Since the IOC created by the activity trace extraction device 100 is generated based on an activity trace having no time dependency and no environmental dependency, it is possible to detect malware without increasing the number of IOCs.

The activity trace extraction device 100 virtually changes the API of the system and the device allocated to the malware process 50c in the case of the third environment; however, the present invention is not limited thereto, and the malware process 50c may be operated by changing an actually available API.

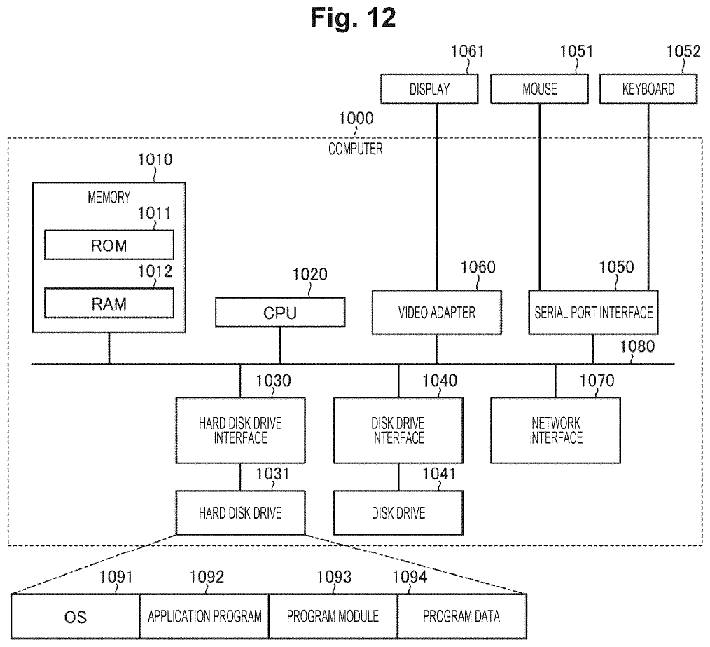

FIG. 12 is a diagram illustrating an example of a computer that executes an activity trace extraction program. A computer 1000 includes, for example, a memory 1010, a CPU 1020, a hard disk drive interface 1030, a disk drive interface 1040, a serial port interface 1050, a video adapter 1060, and a network interface 1070. These units are connected to one another by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. A removable storage medium such as a magnetic disk or an optical disk, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the activity trace extraction program is stored in the hard disk drive 1031 as, for example, the program module 1093 in which a command executed by the computer 1000 is described. Specifically, the program module 1093 in which each piece of the processing executed by the activity trace extraction device 100 described in the above embodiment is described is stored in the hard disk drive 1031.

In addition, data used for information processing by the activity trace extraction program is stored as the program data 1094, for example, in the hard disk drive 1031. The CPU 1020 reads, into the RAM 1012, the program module 1093 and the program data 1094 stored in the hard disk drive 1031 as needed and executes each procedure described above.

Note that the program module 1093 and the program data 1094 related to the activity trace extraction program are not limited to being stored in the hard disk drive 1031, and may be stored in, for example, a removable storage medium and read by the CPU 1020 via the disk drive 1041 or the like. Alternatively, the program module 1093 and the program data 1094 related to the activity trace extraction program may be stored in another computer connected via a network such as LAN or a wide area network (WAN), and may be read by the CPU 1020 via the network interface 1070.

Although the embodiments to which the invention made by the present inventor is applied have been described above, the present invention is not limited by the description and the drawings constituting a part of the disclosure of the present invention according to the present embodiments. In other words, other embodiments, examples, operation techniques, and the like made by those skilled in the art and the like on the basis of the present embodiments are all included in the scope of the present invention.

### REFERENCE SIGNS LIST

100 Activity trace extraction device
110 Communication unit
120 Input unit
130 Display unit
140 Storage unit
141 Target DB
142 History DB
150 Control unit
151 Collection unit
152 Update unit
153 Generation unit

1. An activity trace extraction device, comprising:
collection circuitry that executes malware to collect an analysis log including a plurality of activity traces of the malware, and executes the malware again to collect an environment change analysis log including the plurality of activity traces of the malware assumed in a case where an execution environment of a system and a device used at execution of the malware and information unique to application software are changed;
update circuitry that updates, based on the analysis log and the environment change analysis log, the analysis log by removing, from the analysis log, an activity trace different from an activity trace of the environment change analysis log among the plurality of activity traces included in the analysis log; and
generation circuitry that generates trace information of the malware independent of the execution environment based on the analysis log updated.

2. The activity trace extraction device according to claim 1, wherein:
the collection circuitry executes the malware again in an environment in which time information different from time information at the execution of the malware is indicated to further execute processing for collecting a time change analysis log including the plurality of activity traces of the malware, and
the update circuit updates the analysis log by removing, from the analysis log, an activity trace that is different from an activity trace of the time change analysis log and the activity trace of the environment change analysis log among the plurality of activity traces included in the analysis log.

3. The activity trace extraction device according to claim 1, wherein:
the collection circuitry acquires the execution environment of the system and the device used at the execution of the malware and the information unique to the application software, and further executes processing for applying a change to the execution environment acquired.

4. The activity trace extraction device according to claim 1, wherein;
the generation circuitry creates an indicator of compromise (IOC) based on the analysis log updated.

5. An activity trace extraction method comprising:
executing malware to collect an analysis log including a plurality of activity traces of the malware, and executing the malware again to collect an environment change analysis log including the plurality of activity traces of the malware assumed in a case where an execution environment of a system and a device used at execution of the malware and information unique to application software are changed;
updating, based on the analysis log and the environment change analysis log, the analysis log by removing, from the analysis log, an activity trace different from an activity trace of the environment change analysis log among the plurality of activity traces included in the analysis log; and
generating trace information of the malware independent of the execution environment based on the analysis log updated.

6. A non-transitory computer readable medium storing an activity trace extraction program for causing a computer to execute processing comprising:
executing malware to collect an analysis log including a plurality of activity traces of the malware, and executing the malware again to collect an environment change analysis log including the plurality of activity traces of the malware assumed in a case where an execution environment of a system and a device used at execution of the malware and information unique to application software are changed;
updating, based on the analysis log and the environment change analysis log, the analysis log by removing, from the analysis log, an activity trace different from an activity trace of the environment change analysis log among the plurality of activity traces included in the analysis log; and
generating trace information of the malware independent of the execution environment based on the analysis log updated.
